(19) United States
(12) Patent Application Publication
(10) Pub. No.: US 2026/0208581 A1
(43) Pub. Date: Jul. 23, 2026

(54) ARRANGEMENT FOR AN ASSISTANCE SYSTEM OF A VEHICLE

(71) Applicant: SAINT-GOBAIN SEKURIT FRANCE, THOUROTTE (FR)

(72) Inventors: Markus KEWITZ, HERZOGENRATH (DE); Julian GREVERATH, HERZOGENRATH (DE); Michele CAPPUCCILLI, HERZOGENRATH (DE); Jan HAGEN, HERZOGENRATH (DE)

(21) Appl. No.: 19/136,739

(22) PCT Filed: Dec. 4, 2023
(86) PCT No.: PCT/EP2023/084082

§ 371 Date: Jun. 6, 2025

(30) Foreign Application Priority Data
Dec. 7, 2022 (EP) 22211963.8

(51) Int. Cl. B60K 35/23; G02B 27/01

(52) U.S. Cl. CPC B60K 35/23; G02B 27/0101; B60K 2360/23

(57) ABSTRACT

An arrangement for an assistance system of a vehicle, includes a radiation source for emitting infrared radiation, a radiation receiver for receiving infrared radiation, a windscreen with a reflective layer, and an image display for emitting visible light, with an infrared radiation-reflecting layer. The image display is arranged relative to the reflective layer so that the visible light emitted by the image display is reflected by the reflective layer toward a face of a vehicle occupant, and wherein the radiation source and the radiation receiver are arranged relative to the infrared radiation-reflecting layer so that the infrared radiation emitted by the radiation source is reflected in the following order: via the infrared radiation-reflecting layer, the reflective layer, the face of the vehicle occupant, the reflective layer and the infrared radiation-reflecting layer to the radiation receiver, and is receivable by the radiation receiver.

The invention relates to an arrangement for an assistance system of a vehicle. Furthermore, the invention relates to an assistance system for a vehicle having such an arrangement, to the use of such an arrangement in an assistance system of a vehicle, and to a method for monitoring a vehicle occupant of a vehicle by means of such an assistance system.

Modern vehicles are often equipped with electronic assistance systems, in particular driver assistance systems, that support the driver in guiding the vehicle, for example by automatically applying the brakes if there is a risk of a collision or automatically keeping in a lane if the vehicle leaves the lane. Such driver assistance systems have proved very successful in practice, in particular if they have a monitoring function for the driver, for example to recognise driver fatigue at an early stage, but also to recognise excessive distraction from safe vehicle operation, for example by operating a mobile phone. However, they are increasingly being used not only to monitor the driver, but also to monitor other vehicle occupants. For example, to check the general well-being of the occupants.

For this purpose, it is known to scan the face of the vehicle occupant and in particular their eyes using infrared radiation, which is not visible to the naked eye and thus does not disturb the driver and other vehicle occupants.

Thereby, algorithms may be used to capture the direction and duration of the gaze of the driver, which for example can indicate fatigue if the duration of gaze in a particular direction is unusually long (staring gaze). On the other hand, if the gaze of the driver is averted from the direction of travel too frequently, this may indicate distraction. It is also possible to recognise facial expressions, which can also give an indication of the condition of the vehicle occupant.

EP 1 333 410 A2 discloses a device for the eye tracking of the driver of a vehicle.

DE 10 2014 115 958 A1 discloses a system for monitoring a driver of a vehicle, comprising an infrared flash for shining an infrared beam onto the driver, an infrared camera for capturing an image illuminated by the beam, including reflections, and a reflective infrared film incorporated into the windscreen of the vehicle.

Modern driver assistance systems operate with an infrared-based monitoring function using wavelengths in the range of approximately 1 μm (micrometre) to 2 μm, in particular with infrared radiation with a wavelength of 940 nm or with infrared radiation with a wavelength of 1400 nm or with infrared radiation with a wavelength of 1550 nm. In order to be able to acquire even more information about the vehicle occupants, information is increasingly being collected by means of monitoring functions that operate in the visible light range.

CN217037318U discloses a driver assistance system that uses a visible light camera in addition to an IR camera. WO2022224173A1 discloses a gaze detection system for a driver, wherein a visible light camera can be used as an alternative to an IR camera.

JP201912889 and US2016150218A1 disclose a windscreen with a HUD arrangement. To better align the HUD arrangement for a vehicle occupant, the HUD arrangement may be connected to an infrared camera and an infrared radiation source, which are designed to detect the position of the head of the vehicle occupant. The visible light from the image display of the HUD arrangement as well as the infrared radiation are reflected on the glass of the windscreen.

FR3073053A1 discloses a HUD arrangement and a fatigue detection arrangement comprising an infrared camera and an infrared radiation source. The fatigue detection system can be used to check the condition of the vehicle occupant.

A disadvantage of such solutions is the low degree of reflection on the glass, since visibility through the pane must be maintained in HUD applications.

Vehicle assistance systems are more difficult to adapt to the geometry of a vehicle if the vehicle also has a projection arrangement, such as a HUD display or a high-contrast HUD display. In such cases, the sensors and cameras for the assistance system often have to share the limited space in the vehicle with the image displays intended for the projection arrangements.

The object of the present invention is to provide an improved arrangement for an assistance system of a vehicle with an infrared-based monitoring function for the driver and/or vehicle occupants, which enables simple and reliable acquisition of information about the driver and/or vehicle occupants. In particular, the task is to provide an improved arrangement that utilises the geometry and equipment of modern vehicles efficiently and in a space-saving manner.

According to the proposal of the invention, these and further objects are achieved by an arrangement, by an assistance system, and by a method according to the independent claims. Preferred embodiments can be seen in the dependent claims.

The invention relates to an arrangement for an assistance system for a vehicle, in particular a motor vehicle, with a monitoring function of at least one vehicle occupant of the vehicle based on infrared radiation. The arrangement is particularly suitable for a driver assistance system for monitoring a driver based on infrared radiation. The arrangement comprises a radiation source for emitting infrared radiation and a radiation receiver for receiving infrared radiation. The arrangement further comprises a windscreen, preferably composed of an outer pane and an inner pane, which are connected to one another by a thermoplastic intermediate layer. The windscreen is therefore preferably a composite pane. The windscreen has a reflective layer. The arrangement further comprises an image display with an infrared radiation-reflecting layer, the image display being intended to emit visible light. According to the invention, the reflective layer is arranged on the windscreen in such a manner that, when viewed through the windscreen, as seen by the vehicle occupant, it is arranged entirely against an opaque background of the windscreen.

The radiation source is arranged in such a manner that infrared radiation emitted by the radiation source is directed at the infrared radiation-reflecting layer and is reflected by the infrared radiation-reflecting layer onto the reflective layer and can be reflected by the reflective layer onto the face of a vehicle occupant.

The infrared radiation emitted by the radiation source thus firstly strikes the infrared radiation-reflecting layer of the image display, is reflected by this onto the reflective layer and is then reflected in turn by the reflective layer onto the face of the vehicle occupant. The infrared radiation is reflected by the face of the vehicle occupant back to the reflective layer, the infrared radiation is then reflected by the reflective layer to the infrared radiation-reflecting layer and finally reflected by the infrared radiation-reflecting layer to the radiation receiver.

For ease of reference, the infrared radiation emitted by the radiation source and reflected by the infrared radiation-reflecting layer is referred to as the first reflected radiation. After reflection from the infrared radiation-reflecting layer, the first reflected radiation strikes the reflective layer and can be reflected by the reflective layer onto the face of the vehicle occupant. For ease of reference, the infrared radiation emanating from the infrared radiation-reflecting layer and reflected by the reflective layer is referred to as the second reflected radiation. After reflection by the reflective layer, the second reflected radiation strikes the face of the vehicle occupant and is then reflected by the face of the vehicle occupant. For ease of reference, the infrared radiation emitted by the reflective layer and reflected by the face of the vehicle occupant is referred to as the third reflected radiation. After being reflected by the face of the vehicle occupant, the third reflected radiation strikes the reflective layer and is then reflected by the reflective layer. For ease of reference, the infrared radiation emanating from the face of the vehicle occupant and reflected by the reflective layer is referred to as the fourth reflected radiation. After reflection from the reflective layer, the fourth reflected radiation strikes the infrared radiation-reflecting layer and is then reflected by the infrared radiation-reflecting layer. For ease of reference, the infrared radiation emanating from the reflective layer and reflected by the infrared radiation-reflecting layer is referred to as the fifth reflected radiation. In this case, the radiation receiver is arranged in such a manner that the fifth reflected radiation reflected by the infrared radiation-reflecting layer can be reflected to the radiation receiver and received by the radiation receiver.

Thus, in the arrangement according to the invention, the radiation source, the infrared radiation-reflecting layer, the reflective layer and the radiation receiver are arranged in such a manner that infrared radiation emitted by the radiation source can be reflected by the infrared radiation-reflecting layer as first reflected radiation onto the reflective layer, the first reflected radiation can be reflected by the reflective layer as second reflected radiation onto the face of a vehicle occupant, the second reflected radiation can be reflected by the face of the vehicle occupant onto the reflective layer as third reflected radiation, the third reflected radiation can be reflected by the reflective layer as fourth reflected radiation onto the infrared radiation-reflecting layer, and the fourth reflected radiation can be reflected by the infrared radiation-reflecting layer as fifth reflected radiation to the radiation receiver, and can be received by the radiation receiver.

The image display is arranged relative to the reflective layer in such a manner that visible light emitted by the image display can be reflected by the reflective layer, wherein the reflected visible light can be reflected to a face of a vehicle occupant and can be visually perceived by the vehicle occupant. Due to the opaque background, highly reflective layers, which allow a high degree of reflection for infrared light and visible light, can be used. The visible light is easily perceptible to the vehicle occupants due to the high contrast. This provision represents a high-contrast projection arrangement in the classic sense, which differs significantly from head-up displays (HUD). The image display is therefore designed to project a virtual image, which can be visually perceived by a vehicle occupant, onto the reflective layer.

The windscreen is provided to separate the interior from the external environment in a window opening of a vehicle.

A great advantage of the invention is that, due to the combination of opaque background and reflective layer, highly reflective layers can be used for both visible light and infrared light, since the visible light cannot escape from the vehicle. It is known to a person skilled in the art that the infrared light-reflecting effect generally correlates with the reflectance for the visible radiation range. A further advantage is the space-saving arrangement of the infrared radiation-reflecting layer, the radiation source, and the radiation receiver, which is thus possible in a vehicle. These elements can be combined with the projection arrangement, comprising a reflective layer and an image display, in such a manner that they do not interfere with the vehicle interior. At the same time, they can effectively gather information about a vehicle occupant. The arrangement according to the invention of the infrared radiation-reflecting layer on the image display simplifies the positioning of the radiation receiver and the radiation source. These do not have to be aimed directly at the vehicle occupant, which can be aesthetically disturbing, but can capture the gaze of the vehicle occupant via the infrared radiation-reflecting layer and the reflective layer. The detection of the face of the vehicle occupant is also improved because the occupant can look directly at the image projected onto the reflective layer by the image display; and at the same time information about the vehicle occupant can be acquired by means of the radiation source and radiation receiver. A further advantage of the arrangement according to the invention is that the infrared radiation can strike the face of the vehicle occupant from the front due to the reflection on the reflective layer. The radiation reflected onto the face of the vehicle occupant can thus contain a radiation component which falls perpendicular to the vehicle occupant's face. Likewise, the infrared radiation reflected in a corresponding manner from the face can be received; this contains a radiation component which is reflected perpendicularly from the face of the vehicle occupant.

The windscreen has an interior-side surface which is intended to face the vehicle interior. In addition, the windscreen has an outer-side surface which is intended to face the external environment. In the preferred case that the windscreen comprises an outer pane and an inner pane, these each have an outer-side surface and an interior-side surface, and a peripheral lateral edge running between them. In the context of the invention, the term “outer-side surface” refers to the main surface which is intended to face the external environment in the installed position, wherein the outer-side surface of the outer surface is also simultaneously the outer-side surface of the windscreen. In the context of the invention, the interior-side surface refers to the main surface which is intended to face the interior in the installed position, wherein the interior-side surface of the inner pane is simultaneously also the interior-side surface of the windscreen. The interior-side surface of the outer pane and the outer-side surface of the inner pane face one another and are joined to one another by the thermoplastic intermediate layer. In the context of the invention, the term “inner pane” refers to the pane of the windscreen facing the vehicle interior. Outer pane means the pane facing the external environment.

The outer-side surface of the outer pane is designated as side I. The interior-side surface of the outer pane is designated as side II. The outer-side surface of the inner pane is designated as side III. The interior-side surface of the inner pane is designated as side IV.

For the purposes of the invention, the expression “can be reflected” means that it is also possible that only a portion of the striking radiation is reflected. This also means that it is possible for the striking radiation to be completely reflected.

In a preferred embodiment of the invention, the infrared radiation-reflecting layer is arranged on a surface of the image display facing the windscreen and is permeable to visible light. The surface of the image display facing the windscreen is preferably simultaneously the surface of the image display which is intended to emit visible light onto the reflective layer and is technically suitable for this purpose. Particularly preferably, the infrared radiation-reflecting layer extends over at least 40%, very particularly preferably at least 80%, in particular 100% of the surface of the image display facing the windscreen.

The infrared radiation-reflecting layer is preferably transparent to visible light, particularly if it extends over more than 40% of the surface of the image display facing the windscreen. However, the infrared radiation-reflecting layer may also be opaque, for example if it is arranged outside the surface of the image display, which is intended to emit visible light onto the reflective layer.

The infrared radiation-reflecting layer comprises preferably at least one metal selected from the group consisting of aluminium, tin, titanium, niobium, copper, chromium, cobalt, iron, manganese, nickel-chromium, zirconium, silver, gold, platinum, and palladium, or mixtures thereof. The thickness of the metallic layer is from 50 nm to 1 mm, particularly preferably from 70 nm to 1000 nm, particularly preferably from 80 nm to 500 nm. This achieves particularly good results in terms of the infrared radiation-reflecting effect while maintaining high optical transparency.

In an advantageous embodiment, the infrared radiation-reflecting layer contains at least one transparent, electrically conductive oxide (TCO). Such layers are corrosion-resistant and may be used on exposed surfaces. The infrared radiation-reflecting layer preferably contains indium tin oxide (ITO), which has proven particularly useful. However, the conductive layer can for example also contain aluminium-zinc mixed oxide (AZO), indium-zinc mixed oxide (IZO), gallium-doped tin oxide (GZO), fluorine-doped tin oxide (SnO₂:F) or antimony-doped tin oxide (SnO₂:Sb). The thickness of the transparent, electrically conductive layer is from 50 nm to 1 mm, particularly preferably from 70 nm to 1000 nm, particularly preferably from 80 nm to 500 nm.

In a particularly preferred embodiment, the infrared radiation-reflecting layer contains an alternating layer sequence of high refractive index layers and low refractive index layers. Particularly preferably, the infrared radiation-reflecting layer consists of an alternating layer sequence of high refractive index layers and low refractive index layers. The alternating layer sequence of high refractive index layers and low refractive index layers begins with a high refractive index layer and ends with a high refractive index layer. The surfaces of the infrared radiation-reflecting layer with which the layer stack of the infrared radiation-reflecting layer begins and ends are thus each formed by a high refractive index layer (the remaining layer or layers are therefore located between two high refractive index layers). The alternating layer structure makes possible a homogeneous and sufficiently high degree of reflection of infrared radiation.

With an alternating layer sequence of high refractive index layers and low refractive index layers, the layers immediately adjacent to a low refractive index layer are high refractive index layers, and those immediately adjacent to a high refractive index layer are low refractive index layers.

In a further preferred embodiment, the infrared radiation-reflecting layer contains two high refractive index layers and one low refractive index layer, and the low refractive index layer is arranged between the two high refractive index layers immediately adjacent thereto. Particularly preferably, the infrared radiation-reflecting layer consists of precisely this layer sequence. Thus, in this embodiment, the infrared radiation-reflecting layer has the following layer sequence:

$$High - refractive index layer - low refractive index layer - high refractive index layer .$$

In a further preferred embodiment, the infrared radiation-reflecting layer contains three high refractive index layers and two low refractive index layers, and each of the two low refractive index layers is arranged between two high refractive index layers immediately adjacent thereto. Particularly preferably, the infrared radiation-reflecting layer consists of precisely this layer sequence. Thus, in this embodiment, the infrared radiation-reflecting layer has the following layer sequence:

$$High - refractive index layer - low refractive index layer - high refractive index layer - low refractive index layer - high refractive index layer .$$

In a further preferred embodiment, the infrared radiation-reflecting layer contains four high refractive index layers and three low refractive index layers, and each of the two low refractive index layers is arranged between two high refractive index layers immediately adjacent thereto. Particularly preferably, the infrared radiation-reflecting layer consists of precisely this layer sequence. Thus, in this embodiment, the infrared radiation-reflecting layer has the following layer sequence:

$$High - refractive index layer - low refractive index layer - high refractive index layer - low refractive index layer - high refractive index layer - low refractive index layer - high refractive index layer .$$

Preferably, the infrared radiation-reflecting layer consists of a total of three to seven layers, wherein high refractive index layers and low refractive index layers are arranged in alternating layer sequence and the surfaces of the infrared radiation-reflecting layer with which the layer stack of the infrared radiation-reflecting layer begins and ends are each formed by a high refractive index layer. Particularly preferably, the infrared radiation-reflecting layer additionally has an electrically conductive layer, in particular a metallic layer.

A high refractive index layer preferably has a refractive index greater than 1.9, particularly preferably greater than 2.1, and a low refractive index layer preferably has a refractive index less than 1.6, particularly preferably less than 1.5.

Preferably, the high refractive index layer is formed based on silicon nitride, aluminium nitride, tin-zinc oxide, silicon aluminium nitride, silicon zirconium nitride, silicon titanium nitride, silicon hafnium nitride, or titanium oxide, with it particularly preferably being based on silicon zirconium nitride or particularly titanium oxide. Preferably, the low refractive index layers are formed on the basis of silicon dioxide or doped silicon oxide.

In a preferred embodiment, the thickness of the high refractive index layers is between 50 nm and 200 nm, particularly preferably between 50 nm and 180 nm, most preferably between 80 nm and 150 nm. In a preferred embodiment, the thickness of the low refractive index layers is between 100 nm and 300 nm, particularly preferably between 150 nm and 300 nm, most preferably between 160 nm and 280 nm.

In the context of the present invention, refractive indices are in all cases specified in relation to a wavelength of 550 nm. Methods for determining refractive indices are known to a person skilled in the art. The refractive indices specified within the scope of the invention can for example be determined by ellipsometry, wherein commercially available ellipsometers can be used. Unless otherwise indicated, the specification of layer thicknesses or thicknesses refers to the geometric thickness of a layer.

The infrared radiation-reflecting layer preferably has a reflectance for infrared radiation of at least 20%, particularly preferably at least 40%, most preferably at least 60% and in particular at least 80%. In the context of the invention, the reflection in a certain percentage range means an averaged degree of reflection at a defined angle of incidence of for example 65° to the surface normal of the surface coated with the infrared radiation-reflecting layer. Infrared radiation is radiation with a wavelength within the infrared range, i.e. radiation with a wavelength of 780 nm to 1 mm. The infrared radiation-reflecting layer preferably has a higher reflectance in a wavelength range from 940 nm to 2000 nm, particularly preferably from 940 nm to 1400 nm, than in the other wavelength ranges. This wavelength range is particularly suitable for acquiring information about the vehicle occupants.

The term “reflectance” is used in the sense of the standard DIN EN 410-2011-04. The reflectance always refers to the layer reflectance, which is measured when the coated surface of an element (that is, the image display or windscreen) is facing the light source and the detector.

The reflectance describes the proportion of the total irradiated radiation that is reflected. It is indicated in % (based upon 100%-emitted radiation) or as a unitless number from 0 to 1 (normalised to the emitted radiation). It forms the reflection spectrum when plotted as a function of the wavelength. The reflectance values relate to a reflection measurement with a light source which, within the spectral range under consideration, radiates uniformly with a normalised radiation intensity of 100%.

In a preferred embodiment, the reflective layer is arranged between the inner pane and the outer pane. Particularly preferably, the reflective layer is applied to the outer-side surface of the inner pane or the interior-side surface of the outer pane. In this way, the reflective layer is better protected against corrosion and mechanical damage.

In a further embodiment of the invention, the reflective layer is arranged on an interior-side surface of the windscreen closest to the vehicle occupant. If the windscreen comprises an inner pane, an outer pane and a thermoplastic intermediate layer therebetween, the reflective layer is preferably arranged on the interior-side surface of the inner pane. It is particularly preferred to apply a protective layer over the entire surface of the reflective layer. By arranging the reflective layer on the interior-side surface of the windscreen, ghost images caused by multiple reflections on the windscreen are avoided. The protective layer serves to protect the reflective layer from corrosion or mechanical damage.

In a further particularly preferred embodiment of the invention, the windscreen comprises, in addition to an inner pane, an outer pane and a thermoplastic intermediate layer, also a further pane- and the reflective layer is applied to a surface of the further pane. The further pane is preferably made of transparent glass, in particular of soda lime glass. However, it can also be produced from other glass (for example borosilicate glass, quartz glass, aluminosilicate glass) or transparent plastics (for example polymethyl methacrylate or polycarbonate). The further pane has two surfaces, wherein one surface preferably faces the interior-side surface of the inner pane and the other surface faces away from the interior-side surface of the inner pane. The further pane furthermore has a peripheral edge.

Preferably, the further pane coated with the reflective layer is applied to the interior-side surface or the outer-side surface of the inner pane by means of an adherent layer. The reflective layer is preferably arranged between the further pane and the inner pane. The reflective layer is thus applied to a surface of the further pane that faces the interior-side surface or the outer-side surface of the inner pane. As a result, the reflective layer is better protected against external influences. The reflective layer cannot for example be scraped off without the further pane being detached from the inner pane beforehand. The reflective layer preferably extends over at least 80%, particularly preferably over at least 90%, of the surface of the further pane. In particular, the reflective layer extends over the entire surface of the further pane with the exception of a peripheral frame-shaped edge region that is arranged adjacent to the peripheral edge of the further pane. As a result, the reflective layer is better protected from moisture and corrosion.

The further pane preferably extends over at least 10%, particularly preferably at least 15%, in particular at least 20% of the surface area of the windscreen.

The further pane is preferably thinner than both the inner pane and the outer pane. Alternatively or additionally, the further pane has a thickness of 50 μm to 1000 μm, preferably 150 μm to 500 μm and particularly preferably 150 μm to 250 μm. A good ratio of material cost and mechanical stability is achieved for the inner pane at this thickness. The reflective layer and the further pane are also less aesthetically unpleasing, wherein the optical quality of the windscreen is improved compared to a greater thickness.

The reflective layer preferably has a reflectance for infrared radiation of at least 20%, particularly preferably at least 40%, most preferably at least 60% and in particular at least 80%.

The reflective layer preferably has a degree of reflection for visible radiation of at least 20%, particularly preferably at least 40%, most preferably at least 60% and in particular at least 80%. For the purposes of the invention, reflection in a specific percentage range means an average reflectance at a defined angle of incidence of 65° to the surface normal of the surface coated with the reflective layer. The reflective layer is designed to reflect an image projected from the image display onto the reflective layer, and to reflect the infrared radiation from the radiation source. The reflective layer can be transparent, but is preferably opaque.

The reflective layer preferably comprises at least one metal selected from a group consisting of aluminium, magnesium, tin, indium, titanium, tantalum, niobium, nickel, copper, chromium, cobalt, iron, manganese, zirconium, cerium, scandium, yttrium, silver, gold, platinum and palladium, ruthenium or mixtures thereof. Alternatively or additionally, the reflective layer comprises oxides, carbides, silicon compounds, and/or nitrides selected from a group consisting of boron-doped silicon, silicon-zirconium mixed nitride, silicon nitride, titanium oxide, silicon oxide, titanium carbide, zirconium carbide, silicon zirconium aluminium, or mixtures thereof. Aluminium, titanium, nickel-chromium and/or nickel are preferably applied to the inner pane or the further pane, since they can have a high reflection for visible light and infrared radiation. The reflective layer preferably has a thickness of 10 nm (nanometres) to 100 μm (micrometres), particularly preferably 50 nm to 50 μm, in particular 100 nm to 5 μm.

In a particularly preferred embodiment of the invention, the reflective layer is a coating containing a thin-film stack, i.e., a layer sequence of thin individual layers. This thin-film stack contains one or more electrically conductive layers based on nickel, nickel-chromium, titanium, and/or aluminium. The electrically conductive layer based on nickel, nickel-chromium, titanium, and/or aluminium gives the reflective layer basic reflective properties, and also an infrared radiation-reflecting effect and an electrical conductivity. The electrically conductive layer is based on nickel, nickel-chromium, titanium, and/or aluminium. The conductive layer preferably contains at least 90 wt. % nickel, titanium and/or aluminium, particularly preferably at least 99 wt. % aluminium, and very particularly preferably at least 99.9 wt. % nickel, titanium, and/or aluminium. The layer based on aluminium, nickel-chromium, nickel and/or titanium can have doping, for example palladium, gold, copper, or silver. Materials based on aluminium, nickel, nickel-chromium, and/or titanium are particularly suitable for reflecting light, and particularly preferably p-polarised light and infrared radiation. The use of nickel, nickel-chromium, titanium, and/or aluminium in reflective layers has proven to be particularly advantageous in the reflection of light. Aluminium, nickel, nickel-chromium, and/or titanium are significantly cheaper compared to many other metals such as gold or silver. In addition, these metals have a high chemical and thermomechanical resistance. The individual layers of the thin-film stack preferably have a thickness of 10 nm to 1 μm. The thin-film stack preferably has 2 to 20 individual layers and in particular 5 to 10 individual layers.

In a very particularly preferred embodiment of the invention, the reflective layer is a reflective film that is metal-free. The reflective layer is then preferably a film which functions on the basis of synergistically interacting prisms and reflective polarisers. The reflective layer preferably has a carrier film based on polyvinyl chloride or polyethylene terephthalate. Synergistically interacting prisms and reflective polarisers are applied to this carrier film. Such films for the use of reflective layers are commercially available—for example, from the 3M company. In this way, complex metal deposition can be avoided. The reflective layer is applied as a reflective film, preferably via an adhesive layer, to the interior-side surface of the windscreen, optionally the inner pane, or is arranged within the thermoplastic intermediate layer (for example by pressing the reflective layer into the thermoplastic intermediate layer or between two thermoplastic composite films). Alternatively, the reflective layer can also be applied as a reflective film to the further pane by means of an adherent layer.

In a further particularly preferred embodiment of the invention, the reflective layer contains
a dielectric layer stack containing TiO₂ layers and SiO₂ layers,
a dielectric layer stack containing SiZrN layers and SiO₂ layers,
a layer stack containing Si:B layers or SiZrAl layers,
a layer stack containing Si layers and SiO₂ layers,
a layer stack containing Si layers and Si₃N₄ layers, or
a carbide layer stack containing TiC layers and/or ZrC layers
or consists of one or more of these layer stacks. The described layer stacks have suitable reflection properties to achieve a homogeneous image as part of a projection arrangement and also to have a sufficiently high degree of reflection for infrared radiation. Preferably, the layer stacks described above are applied as a coating to the windscreen, in particular to the inner pane or the further pane.

Preferably, the reflective layer does not extend in a peripheral, frame-shaped edge region of the windscreen (adjacent to a peripheral edge of the windscreen). The uncoated, peripheral, frame-shaped edge region serves to better separate the reflective layer from the external environment. The reflective layer is accordingly better protected from corrosion or mechanical damage. The coating-free edge region preferably has a width of less than 20 cm, particularly preferably less than 10 cm, in particular less than 1 cm.

The windscreen has a peripheral edge, which particularly preferably comprises an upper edge and a lower edge, and two lateral edges running between them—with a left and a right lateral edge. Upper edge means the edge intended to point upwards in the installed position. Lower edge means the edge intended to point downwards in the installed position. The upper edge is often also referred to as the roof edge, and the lower edge is often also referred to as the engine edge. The windscreen can have any suitable geometric shape and/or curvature. The indications “left” and “right” refer to the side indication or directional indication for an observer looking at the installed windscreen according to the invention from a interior.

In a particularly preferred embodiment, the reflective layer preferably extends at most over 50%, particularly preferably at most over 40%, in particular at most over 20%, of the area of the windscreen. Particularly preferably, the reflective layer is arranged in an upper edge region of the windscreen adjacent to the upper edge, and/or in a lower edge region of the windscreen adjacent to the lower edge of the windscreen, wherein preferably a coating-free edge region is located between the reflective layer and the upper edge and/or lower edge. Alternatively, the reflective layer can also be arranged in addition or exclusively in a lateral edge region adjacent to one or both lateral edges of the windscreen, wherein in this case too a coating-free edge region is preferably located between the reflective layer and the adjacent lateral edge (left and/or right lateral edge). The coating-free edge region preferably has a width of less than 20 cm, particularly preferably less than 10 cm, in particular less than 1 cm. The reflective layer preferably extends in a strip shape from the one (left) lateral edge to the other (right) lateral edge and is in particular adjacent to the lower edge of the windscreen. The reflective layer preferably has a width of at least 10 cm, particularly preferably at least 20 cm, in particular at least 30 cm. This embodiment is particularly suitable since the reflective layer is not intended to be arranged in the see-through region. This enables higher reflection values for visible light and infrared radiation. This arrangement is often used for projection arrangements that require a high-contrast image.

According to the invention, the reflective layer is arranged on the windscreen in such a manner that, when viewed through the windscreen, as seen by the vehicle occupant, it is arranged entirely against an opaque background of the windscreen. Put another way: when viewed from the outside, the reflective layer is completely hidden by the opaque background when viewed through the windscreen. It is understood that the opaque background is arranged behind the reflective layer in a perspective looking through the windscreen from the vehicle interior. The opaque background can thus be arranged congruently with the reflective layer or extend over the area of the windscreen beyond the area of the reflective layer. Viewing through the windscreen means a viewing direction perpendicular to the main surface of the windscreen. Within the meaning of the invention, the “complete coverage of an element A with an element B” means that the orthonormal projection of element A to the plane of element B is arranged completely within element B. This arrangement creates a high contrast, which makes virtual images created by visible light more visually perceptible. It also allows the use of reflective layers that have a lower transparency, allowing the use of reflective layers that have a higher reflectivity for infrared radiation and visible light.

The opaque background can be created by an opaque enamel (also called screen printing) or an opaque thermoplastic film, which are arranged behind the reflective layer when viewed from the vehicle interior. The opaque background can also be produced by a thermoplastic film that is opaque in regions and thus a component of the thermoplastic intermediate layer. The opaque background is in particular produced by a dark, preferably black, enamel which is applied to the outer pane. The enamel is preferably applied to the interior-side surface of the outer pane. However, the enamel can also be applied to the interior-side surface of the inner pane. The opaque background is preferably produced by a peripheral (frame-shaped) layer which extends along the peripheral edge of the windscreen and can be widened in the region of the reflective layer. Enamels serve primarily as UV protection for the structural adhesive of the windscreen (for example, for gluing into a vehicle). The opaque background preferably has a transmittance (according to ISO 9050:2003) for visible light of less than 15%, preferably less than 10%, particularly preferably less than 1%. The opaque background can also be designed to be semi-transparent, at least in sections—for example, as a dot matrix, stripe matrix, or chequered matrix. Alternatively, the opaque background can also have a gradient—for example, from an opaque coverage to a semi-transparent coverage. The opaque background is preferably also opaque to infrared light, with a transmittance for infrared light of less than 10%, particularly preferably less than 1%.

“Width” within the meaning of the invention means the extent perpendicular to the extension direction.

Within the meaning of the invention, “opaque” means a light transmission (according to ISO 9050:2003) of less than 30%, preferably less than 20%, particularly preferably less than 5%, and in particular less than 0.1%. Within the context of the invention, “transparent” means a light transmission (according to ISO 9050:2003) of at least 50%, preferably at least 60%, particularly preferably at least 70%, and especially at least 80%. The values for light transmittance (TL) refer (as is usual for automotive glazing) to illuminant A, i.e., the visible portion of sunlight at a wavelength of 380 nm to 780 nm, thus substantially the visible spectrum of solar radiation. Infrared beams are understood to mean beams of a wavelength greater than approximately 780 nm.

If thin layers are mentioned, that is to say layers with a thickness of below 1000 nm, the following applies: if something is formed “on the basis” of a material, it consists predominantly of this material, in particular substantially from this material in addition to any impurities or doping. Unless otherwise indicated, the specification of layer thicknesses or thicknesses refers to the geometric thickness of a layer.

If something is formed “on the basis” of a polymeric material, it consists predominantly, that is to say at least 50%, preferably at least 60%, and in particular at least 70%, of this material. It can thus also contain further materials such as for example stabilisers or plasticisers.

This layer structure of the reflective layer and/or of the infrared radiation-reflecting layer is generally obtained by a sequence of deposition processes which are carried out by a vacuum method, such as magnetic-field-assisted cathode sputtering or by chemical gas-phase deposition (CVD). Alternatively, the layer structure of the functional layer can also be obtained by wet coating.

The thermoplastic intermediate layer is preferably formed as at least one thermoplastic laminated film and is based on ethylene vinyl acetate (EVA), polyvinyl butyral (PVB), or polyurethane (PU) or mixtures or copolymers or derivatives thereof, particularly preferably based on polyvinyl butyral (PVB) and, in addition, additives known to a person skilled in the art, for example plasticisers. The thermoplastic film preferably contains at least one plasticiser.

The thermoplastic intermediate layer can be formed by one or more thermoplastic films arranged one above the other, wherein the thickness of the thermoplastic intermediate layer after the lamination of the layer stack is preferably from 0.25 mm to 1 mm, typically 0.38 mm or 0.76 mm. The thermoplastic intermediate layer can also be formed from a film which is dyed in regions and thus opaque. The opaque background can therefore also be a component of the thermoplastic intermediate layer. The intermediate layer can also be formed from more than one film and the at least two films can extend over different regions of the area of the windscreen.

The outer pane and the inner pane are preferably made of transparent glass, in particular of soda-lime glass, which is customary for vehicle panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range from 0.8 mm to 5 mm, preferably from 1.4 mm to 2.5 mm, are used, for example those with the standard thicknesses of 1.6 mm or 2.1 mm. Independently of each other, the outer pane, the further pane and the inner panes can be not prestressed, partially prestressed or prestressed. If at least one of the panes is to be tempered, this can be thermal or chemical prestressing.

The outer pane, the inner pane, and the windscreen can have any three-dimensional shape. Preferably, the inner pane and the outer pane do not have any shadow zones, so that they can be coated efficiently by cathode sputtering. The inner pane and the outer pane and thus also the windscreen are preferably flat or slightly or strongly curved in one direction or in several spatial directions. The optionally present further pane is preferably curved in the same shape as the windscreen or optionally the inner pane in the region of the reflective layer.

In a further embodiment of the invention, the arrangement according to the invention comprises a further radiation receiver, wherein the further radiation receiver is directed preferably towards the face of the vehicle occupant such that visible light reflected by the face of the vehicle occupant can be at least partially received by the further radiation receiver. In this way, further information about the vehicle occupant can be acquired. The visible spectral range can be used to acquire information (e.g. certain vital signs) that cannot be acquired using infrared radiation. Alternatively or additionally, the visible light received by the further radiation receiver can be used for video transmission (for example for digital communication outside or inside the vehicle).

In a preferred embodiment of the invention, a functional layer is arranged, preferably applied, on the surface of the image display facing the windscreen. The functional layer is transparent to p-polarised visible light and reflective to s-polarised visible light. The functional layer preferably has a reflectance of at least 20%, particularly preferably of at least 40%, very particularly preferably of at least 60%, in particular of at least 80% for striking s-polarised visible light. The functional layer preferably extends over at least 40%, very particularly preferably over at least 80%, in particular over 100% of the surface of the image display facing the windscreen.

The radiation receiver is preferably suitable for receiving visible light in addition to infrared radiation, so that s-polarised visible light reflected by the face of the vehicle occupant can be reflected via the reflective layer and then via the functional layer and received by the radiation receiver. Alternatively, a further radiation receiver is arranged relative to the functional layer and the reflective layer in such a manner that s-polarised visible light reflected by the face of the vehicle occupant can be reflected via the reflective layer and then via the functional layer and received by the further radiation receiver. For the purposes of the invention, “reflected via the reflective layer and then via the functional layer to the radiation receiver or further radiation receiver” means that the visible s-polarised light reflected by the face of the vehicle occupant at least partially strikes the reflective layer and is at least partially reflected by the reflective layer. The visible s-polarised light reflected by the reflective layer at least partially strikes the functional layer and is at least partially reflected by the functional layer. The visible s-polarised light reflected by the functional layer is at least partially reflected towards the radiation receiver or the further radiation receiver, so that the radiation receiver or the further radiation receiver can receive the visible s-polarised light. In this embodiment, the image display preferably emits more than 50%, particularly preferably more than 70%, in particular exclusively, p-polarised light, which can transmit through the functional layer. This arrangement allows information about the vehicle occupants to be obtained using the visible spectral range while maintaining a space-saving and aesthetically unobtrusive solution. The visible s-polarised light can be generated by a further radiation source that shines directly or indirectly onto the face of the vehicle occupant. However, the visible s-polarised light can also be exclusively or additionally natural light from the external environment (solar radiation). The person skilled in the art is aware that natural light contains both p-polarised and s-polarised light.

In a particularly preferred embodiment of the invention, a linear polariser is arranged between the radiation receiver or the optionally further radiation receiver and the image display. The linear polariser is transparent to visible s-polarised light but opaque to visible p-polarised light. The linear polariser is preferably arranged between the radiation receiver and the functional layer in such a manner that visible light reflected by the functional layer first strikes the linear polariser before it can strike the radiation receiver and be received by the radiation receiver. Alternatively, the linear polariser is arranged between the further radiation receiver and the functional layer in such a manner that visible light reflected by the functional layer first strikes the linear polariser before it can strike the further radiation receiver and be received by the further radiation receiver. This also applies to p-polarised light emitted by the image display, which is transmitted through the functional layer and would strike the radiation receiver, or possibly the further radiation receiver, if it is not previously absorbed by the linear polariser. The beam path of the visible light and p-polarised light from the functional layer to the radiation receiver or optionally further radiation receiver is thus interrupted by the linear polariser, wherein the s-polarised portion of the visible light is transmitted through the linear polariser and the p-polarised light is absorbed by the linear polariser. For technical reasons, part of the p-polarised light emitted by the image display is oriented in such a manner that it is transmitted through the functional layer and then strikes the radiation receiver or the further radiation receiver. Due to the linear polariser, which is arranged between the functional layer and the (further) radiation receiver, the p-polarised light emitted by the image display cannot be received by the (further) radiation receiver. The linear polariser prevents p-polarised light emitted by the image display from striking the radiation receiver or optionally further radiation receiver, as otherwise undesirable image overlays would be the result.

Preferably, a circular polariser is arranged between the radiation receiver or the further radiation receiver and the linear polariser, so that the s-polarised light transmitted by the linear polariser is first transmitted through the circular polariser, and accordingly circularly polarised. The light that is now circularly polarised at the circular polariser can then, for technical reasons, be at least partially reflected at the (further) radiation receiver (reflection, for example, at a lens of the (further) radiation receiver). The circularly polarised light reflected at the radiation receiver or optionally further radiation receivers changes its direction of rotation when reflected, i.e. it now has a reversed direction of rotation. The circular polariser is arranged between the linear polariser and the radiation receiver or optionally further radiation receiver in such a manner that the reflected circularly polarised light is reflected towards the circular polariser, then transmitted through the circular polariser, wherein the circularly polarised light with the opposite direction of rotation at the circular polariser changes the polarisation to p-polarisation and then strikes the linear polariser. The linear polariser is designed in such a manner that the p-polarised light is absorbed by the linear polariser. S-polarised light striking the circular polariser is therefore circularly polarised, then the circularly polarised light is reflected at the radiation receiver or optionally further radiation receiver, wherein the circularly polarised light reverses its direction of rotation, then the circularly polarised light with the opposite direction of rotation strikes the circular polariser again, wherein the circularly polarised light with the opposite direction of rotation changes its polarisation to p-polarised light. The p-polarised light then strikes the linear polariser, where the p-polarised light is absorbed. The circular polariser in conjunction with the linear polariser can prevent the circularly polarised light reflected at the radiation receiver or further radiation receiver from entering the field of vision of the vehicle occupant via subsequent reflection at the functional layer and the reflective layer.

The circular polariser is an optical element that creates a phase shift in the transmitted light. The desired delay is achieved by varying the thickness and the alignment of the circular polariser in the beam path. With a circular polariser there is a phase shift of 90°. The circular polariser is also called λ/4 plate or quarter-wave plate. Suitable circular polarisers are known to a person skilled in the art. Circular polarisers consist of birefringent materials. Birefringent materials have refractive indices for light that deviate slightly from one another.

In a preferred embodiment, the λ/4 circular polariser is designed as a polymeric circular polariser. λ/4 circular polarisers are commercially available in the form of birefringent plastics films. In another preferred embodiment, the λ/4 circular polariser is designed as a circular polariser made of crystalline quartz or sapphire.

Preferably, the linear polariser is made of a polymer film which is stretched in one direction. The linear polariser preferably consists of a polyvinyl alcohol film (PVA film) that has been stretched and coloured with iodine during the manufacturing process. Optionally, the PVA film of the linear polarisation filter can be laminated on both sides with an optically neutral cellulose triacetate carrier. Suitable linear polarisers with absorbing properties for p-polarised light are known to a person skilled in the art.

The radiation source, the radiation receiver and, if applicable, the further radiation receiver must be positioned for the indirect irradiation of the face only with regard to a suitable reflection of the infrared radiation or visible light radiation on the reflective layer and infrared radiation-reflecting layer or functional layer, which can generally be done in such a manner that they are not or at least practically not visible to the vehicle occupants. For example, they can be located in the rear region of the vehicle's dashboard. This is a further advantage of the invention.

The radiation source is preferably a thermal radiator, such as incandescent lamps and radiant heaters. The radiation source can also be a selective radiator such as a Nernst lamp, an incandescent mantle or a high-pressure gas discharge lamp. In particular, the radiation source is an infrared light-emitting diode (IR-LED). The radiation source can also be an infrared laser, for example a semiconductor laser, a Nd:YAG laser or a CO₂ laser. The radiation receiver is preferably a thermal detector. If infrared radiation from 800 nm to 1400 nm is used, the radiation receiver is preferably a semiconductor detector.

The indication of the polarisation direction here refers to the plane of incidence of the radiation on the windscreen. P-polarised radiation refers to a radiation the electric field of which oscillates in the plane of incidence. S-polarised radiation refers to a radiation the electric field of which oscillates perpendicular to the plane of incidence. The plane of incidence is spanned by the incident vector and the surface normal of the windscreen in the geometric centre of the irradiated region.

The functional layer is preferably a reflective, linear polarisation filter, in particular a broadband wire grid polarisation filter. The polarisation filter is designed to reflect s-polarised light but allow p-polarised light to pass through. Wire grid polarisation filter (wire-grid polarisers) are generally known to a person skilled in the art. Wire grid polarisation filters contain wires which are preferably applied to a first transparent layer, preferably made of glass, in particular quartz glass. A second transparent layer, preferably made of glass, in particular quartz glass, is applied to the wires as a protective layer. The wires are therefore arranged between a first and a second protective layer. In order to achieve the desired polarisation effect, the wires are applied parallel to each other on the first transparent layer. Electromagnetic waves (visible light), with a component of their electric field aligned parallel to the wires, induce the movement of electrons along the length of the wires. Since the electrons are free to move in this direction, the polariser behaves similarly to the surface of a metal when reflecting light, and the wave is reflected back along the incident beam (minus a small amount of energy lost due to Joule heating of the wire). For electromagnetic waves with electric fields perpendicular to the wires, the electrons cannot move very far across the width of the individual wires. Therefore, only a small amount of energy is reflected and the incident wave can penetrate the grating. In this case, the grid behaves like a dielectric material. In the context of the invention, this means that visible light is polarised by the birefringent properties of the wire grid polarisation filter. The visible light striking the wire grid polarisation filter is reflected depending on the polarisation of the light components, or it can be transmitted through the wire grid polarisation filter. P-polarised light is transmitted to a dielectric (can therefore be transmitted through the wire grid polarisation filter), while s-polarised light is reflected. The wires preferably contain metal, preferably aluminium. The wires are particularly preferably made of aluminium. The metal layer preferably has a diameter of 100 nm to 10 μm, particularly preferably of 500 nm to 5 μm, in particular of 1 μm to 3 μm. The distance between the wires is preferably less than 780 nm, particularly preferably less than 400 nm, in particular less than 100 nm.

The image display is preferably a liquid-crystal display (LCD), thin-film transistor (TFT) display, light-emitting diode (LED) display, organic light-emitting diode (OLED) display, electroluminescent display (ELD), or micro-LED display.

The technical terms used here from the field of HUDs are generally known to a person skilled in the art. For a detailed depiction, reference is made to the dissertation, “Simulation-based measurement technique for testing head-up displays”, by Alexander Neumann of the Institute for Informatics of the Technical University of Munich (Munich: University Library of TU Munich, 2012)—in particular, to Chapter 2, “The Head-Up Display”.

The above-mentioned desired reflection characteristics of the reflective layer, the infrared radiation-reflecting layer, and the functional layer are achieved in particular by the choice of materials and thicknesses and the structure of the individual layers or layer sequences.

The invention further extends to an assistance system, in particular a driver assistance system, with an infrared-based and possibly visible light-based monitoring function for the vehicle occupant, in particular the driver, of a vehicle, which comprises an arrangement according to the invention. The assistance system further comprises at least one actuator and/or at least one signal output device, along with an electronic control device that is configured to acquire information about the vehicle occupant on the basis of an output signal of the radiation receiver, and optionally of the further radiation receiver and to output an electrical signal to the at least one actuator for performing a mechanical action and/or to the at least one signal output device for outputting a visual and/or acoustic signal on the basis of the acquired information about the vehicle occupant.

Preferably, the control device acquires an ACTUAL value from the deviation of the signals emitted by the radiation source and the radiation receiver. This ACTUAL value can be compared with a TARGET value range stored on the control device. The TARGET value range indicates a value range in which no electrical signal is to be output to the at least one actuator for carrying out a mechanical action and/or to the at least one signal output device for outputting an optical and/or acoustic signal. This is a range of values that reflects for example an alert, attentive and healthy vehicle occupant. The control device is designed in such a manner that if the ACTUAL value deviates from the TARGET value range, i.e. if the ACTUAL value is outside the TARGET value range, an electrical signal is then sent to the at least one actuator for carrying out a mechanical action and/or to the at least one signal output device for outputting an optical and/or acoustic signal. Preferably, the TARGET value range is obtained by a previous calibration and stored digitally on the control device.

Furthermore, the invention extends to a method for monitoring a vehicle occupant of a vehicle, in particular a driver, in which method an assistance system according to the invention is provided. The method comprises at least the following steps:
(a) Infrared radiation is emitted from the radiation source and reflected to the radiation receiver in the following order: via the infrared radiation-reflecting layer, the reflective layer, the face of the vehicle occupant, the reflective layer, and the infrared radiation-reflecting layer.
(b) The infrared radiation is received by the radiation receiver.
(c) Information about the vehicle occupant is acquired by the electronic control device on the basis of the infrared radiation received by the radiation receiver.
(d) On the basis of the information, an action is carried out by the actuator and/or an optical and/or acoustic signal is output by the signal output device.

It is understood that the method follows the order (a), (b), (c), and finally (d).

In a preferred embodiment of the method according to the invention, in method step (a), s-polarised visible light is reflected by the face of the vehicle occupant via the reflective layer and then via the functional layer to the radiation receiver or optionally to the further radiation receiver. In method step (b), the s-polarised visible light is received by the radiation receiver or optionally the further radiation receiver.

In method step (c), further information about the vehicle occupant is acquired by the electronic control device on the basis of the visible s-polarised light received by the radiation receiver or optionally the further radiation receiver.

In method step (d), an action is carried out by the actuator on the basis of the further information and/or an optical and/or acoustic signal is output by the signal output device.

Preferably, in method step (c), an ACTUAL value is acquired by means of the control device from the deviation of the signals emitted by the radiation source and the radiation receiver. This ACTUAL value is compared with the TARGET value range stored on the control device. In method step (d), if the ACTUAL value deviates from the TARGET value range, then on the basis of the detected deviation an action is carried out by the actuator and/or an optical and/or acoustic signal is output by the signal output device.

In a further preferred embodiment, in method step (c) a further ACTUAL value is acquired from the received signal of the further radiation source by means of the control device. This further ACTUAL value is compared with a further TARGET value range stored on the control device. In method step (d), if the further ACTUAL value deviates from the further TARGET value range, an action is carried out by the actuator on the basis of the detected deviation and/or an optical and/or acoustic signal is output by the signal output device.

The preferred designs of the arrangement according to the invention described above also apply accordingly to the method according to the invention.

Furthermore, the invention extends to the use of the arrangement according to the invention in an assistance system, in particular a driver assistance system of a vehicle, in particular a motor vehicle, for transport on land, on water, or in the air.

The various embodiments of the invention can be implemented individually or in any combinations. In particular, the features mentioned above and explained below can be used not only in the specified combinations but also in other combinations or alone without departing from the scope of the present invention.

The invention is explained in more detail below with reference to exemplary embodiments, wherein reference is made to the accompanying FIGURES. The FIGURES are schematic representations and are not true to scale. The FIGURES do not limit the invention in any way. In the drawings:

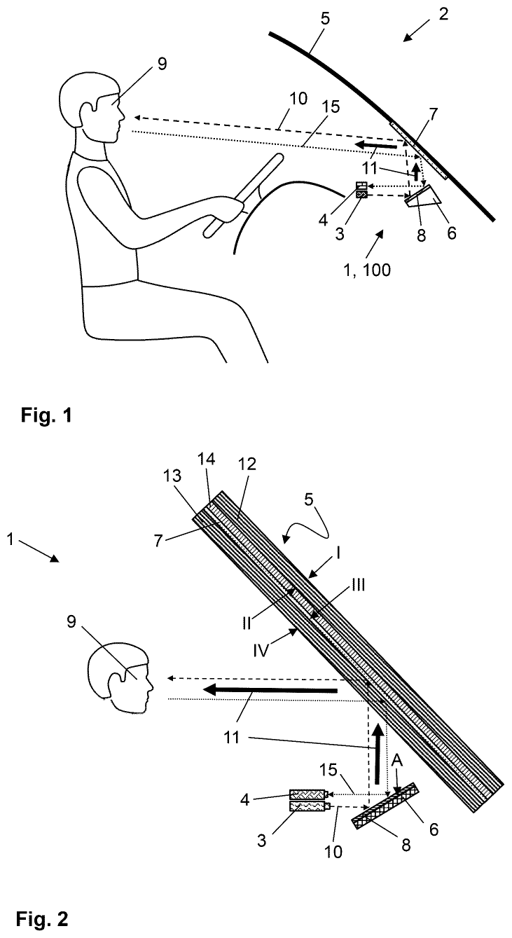

FIG. 1 is a schematic view of the front part of a vehicle with driver, with an arrangement and a driver assistance system for infrared-based monitoring of the driver,

FIG. 2 is the arrangement of FIG. 1 in enlarged cross-section,

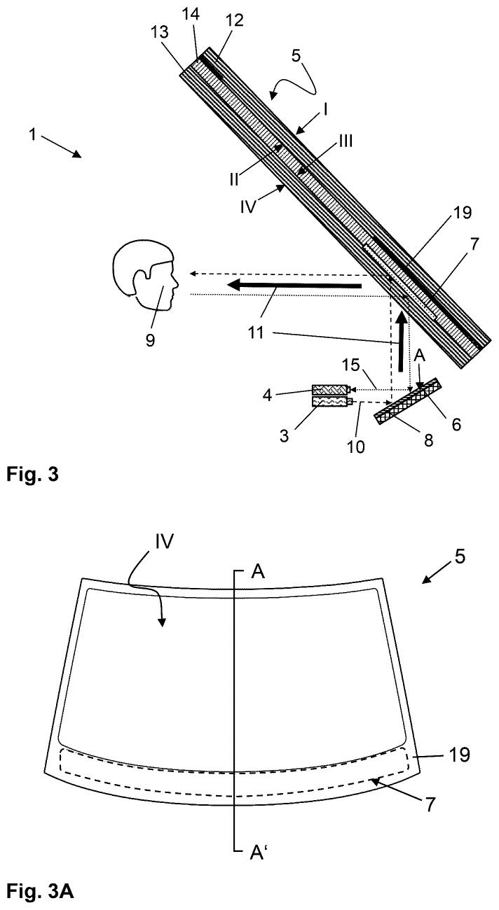

FIG. 3 is an embodiment of an arrangement according to the invention in cross-section,

FIG. 3A is a plan view of the windscreen of the embodiment of FIG. 3, and

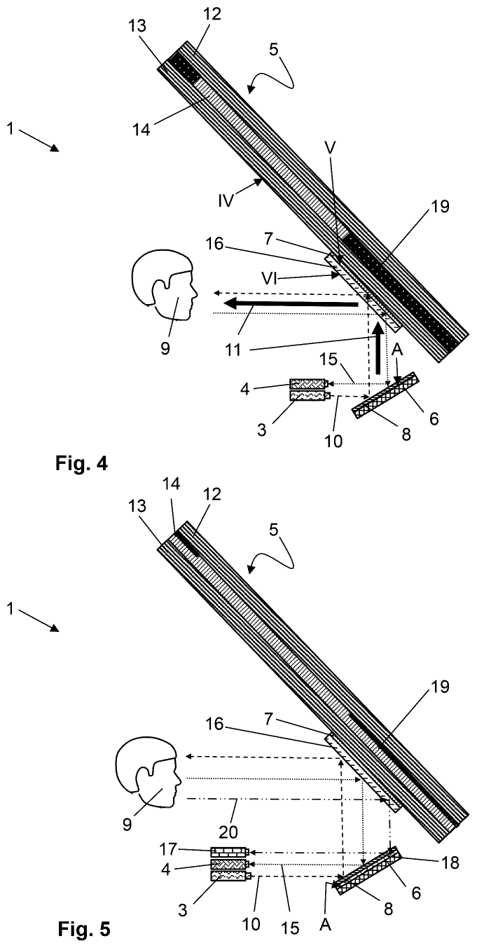

FIG. 4-5 are further embodiments of the arrangement according to the invention, shown in cross-section.

FIG. 1 is a schematic view of the front part of a vehicle 2 with a vehicle occupant who is the driver of the vehicle 2, with an arrangement 1 and a driver assistance system 100 for infrared-based monitoring of the vehicle occupant. The arrangement 1 is shown enlarged in FIG. 2.

The arrangement 1 comprises a windscreen 5 of a vehicle 2 which has an outer pane 12 and an inner pane 13 which are fixedly connected to one another by a thermoplastic intermediate layer 14, and also a reflective layer 7 (see FIG. 2).

The windscreen 5 has an upper edge and a lower edge and two lateral edges connecting the upper edge and the lower edge (all together results in a peripheral edge of the windscreen 5). The lower edge (also called the motor edge) of the windscreen 5 means the edge that faces the floor in the installed position. The upper edge (also called the roof edge) of the windscreen 5 means the edge that faces the vehicle roof in the installed position in the vehicle 2.

The outer pane 12 and the inner pane 13 each consist of glass, preferably thermally pre-stressed soda-lime glass, and are transparent to visible light 11. The outer pane 12 has for example a thickness of 2.1 mm and the inner pane 13 has for example a thickness of 1.5 mm. The thermoplastic intermediate layer 14 comprises a thermoplastic, preferably polyvinyl butyral (PVB), ethylene vinyl acetate (EVA), and/or polyethylene terephthalate (PET), and is for example 0.8 mm thick.

The reflective layer 7 is for example a dielectric layer stack containing TiO₂ layers and SiO₂ layers. The reflective layer 7 is applied for example by means of magnetron sputtering to the outer-side surface III of the inner pane 13. The reflective layer 7 extends over the entire surface III of the inner pane 13 with the exception of a peripheral, frame-shaped edge region which is arranged adjacent to the peripheral edge of the windscreen 5.

The arrangement 1 also comprises an image display 6 with an infrared radiation-reflecting layer 8. The image display 6 is intended to emit a virtual image by means of visible light 11 onto the reflective layer 7. The virtual image is reflected on the reflective layer 7 towards the face 9 of the vehicle occupant (indicated by bold arrows in FIG. 2), so that the vehicle occupant can visually perceive the virtual image in the form of visible light 11. The reflective layer 7 on the inner pane 13 together with the image display 6 form a head-up display. The image display 6 is for example a light-emitting diode display (LED display).

The infrared radiation-reflecting layer 8 is applied flat to a surface A of the image display 6 facing the windscreen 5. The surface A of the image display 6 facing the windscreen 5 is at the same time the surface of the image display 6 via which the visible light 11 of the image display 6 can be emitted in the direction of the reflective layer 7. The visible light 11 of the image display 6 is for example exclusively p-polarised light in order to avoid ghost images when reflected on the windscreen 5.

The arrangement 1 furthermore comprises a radiation source 3 and a radiation receiver 4 which, as shown schematically in FIGS. 1 and 2, can be arranged next to one another, but can also be installed in an assembly. Both the radiation source 3 and the radiation receiver 4 are installed in this case for example in the rear region of a dashboard (located closer to the windscreen 5 than to the vehicle occupant) of the vehicle 2, where they are practically invisible to vehicle occupants. The radiation source 3 is positioned and aligned in such a manner that the infrared radiation 10 emitted by the radiation source 3 strikes the infrared radiation-reflecting layer 8 and is reflected there by the infrared radiation-reflecting layer 8 to the reflective layer 7. The infrared radiation 10 emanating from the infrared radiation-reflecting layer 8 is reflected by the reflective layer 7 onto the face 9 of the vehicle occupant. The infrared radiation 10, hereinafter referred to as infrared reflected radiation 15 for clarity, is reflected by the face 9 of the vehicle occupant in the direction of the reflective layer 7. The infrared reflected radiation 15 is reflected by the reflective layer 7 onto the infrared radiation-reflecting layer 8. The infrared reflected radiation 15 is reflected by the infrared radiation-reflecting layer 8 onto the radiation receiver 4. The radiation receiver 4 is oriented toward the surface A of the image display 6 coated with the infrared radiation-reflecting layer 8, and can receive the infrared reflected radiation 15 reflected by the infrared radiation-reflecting layer 8. The infrared radiation 10 which is reflected by the reflective layer 7 onto the face 9 of the vehicle occupant preferably strikes the face 9 of the vehicle occupant substantially perpendicularly, assuming a normal sitting position of the vehicle occupant in the vehicle 2. The infrared radiation 10 is preferably reflected back substantially perpendicularly as infrared reflected radiation 15 from the face 9 of the vehicle occupant to the reflective layer 7. In this way, particularly suitable and extensive information about the condition of the vehicle occupant can be obtained.

The infrared radiation-reflecting layer 8 is for example a layer stack with two high refractive index layers and one low refractive index layer. The high refractive index layers are for example based on silicon nitride. The low refractive index layer is for example formed on the basis of nanoporous silicon oxide.

The radiation source 3 is for example an infrared light-emitting diode (IR-LED). The radiation receiver 4 is for example a thermal detector.

Based on the driver data collected in this way, information about the vehicle occupant, in this case the driver, can be acquired in a particularly reliable manner. Thus, features of the face 9, such as facial expressions and eye movements, can be acquired particularly well and reliably. In addition, the radiation source 3, the image display 6, and the radiation receiver 4 can be arranged in the rear region of the dashboard, such that they can be easily integrated into the interior of the vehicle 2 and do not interfere with the design of the vehicle interior. By integrating the projection arrangement, i.e. the head-up display with reflective layer 7 and image display 6, into the arrangement 1 for monitoring the vehicle occupant, the limited space available in a vehicle 2 can be used optimally.

Reference is now made to FIGS. 3 and 3A, which show an enlarged cross-sectional view and a plan view of the windscreen 5 from a vehicle interior. FIGS. 3 and 3A relate to an embodiment of the invention. The cross-sectional view of the windscreen 5 in FIG. 3 corresponds to the section line A-A′, which is indicated in FIG. 3A. The variants shown in FIG. 3 and FIG. 3A correspond substantially to the variant from FIG. 1 and FIG. 2, and therefore only the differences will be discussed here, and reference is otherwise made to the description relating to FIG. 1 and FIG. 2.

Unlike the variant from FIG. 1 and FIG. 2, the reflective layer 7 in FIG. 3 and FIG. 3A does not extend over the entire outer-side surface III of the inner pane 13, but is arranged only in a lower edge region of the windscreen 5. The reflective layer 7 extends in a strip shape with a width of approximately 15 to 20 cm from the left lateral edge of the windscreen 5 to the right lateral edge of the windscreen 5. Between the reflective layer 7 and the left and right lateral edges of the windscreen 5 there is an area approximately 5 cm wide that is not coated with the reflective layer 7. Between the reflective layer 7 and the lower edge of the windscreen 5 there is also an area approximately 5 cm wide that is not coated with the reflective layer 7. The reflective layer 7 is thus arranged outside an area of the windscreen 5 intended for visibility. The reflective layer 7 is also arranged in front of an opaque background 19 when viewed through the windscreen 5 from the vehicle interior. Simultaneously this means that the reflective layer 7 is completely obscured by the opaque background 19 when viewed through the windscreen 5 from the external environment.

The opaque background 19 is designed for example in the form of a black screen print applied to the interior-side surface II of the outer pane 12. The screen printing extends in a frame shape along the peripheral edge of the windscreen 5 (see FIG. 3A). The screen print is applied wider along the lower edge of the windscreen 5, so that the reflective layer 7 is arranged completely in front of the screen print, i.e. the opaque background 19. The screen printing serves, among other things, as UV protection for the mounting adhesive of the windscreen 5 (for example, for gluing into the vehicle 2).

By arranging the reflective layer 7 outside the area of the windscreen 5 intended for viewing, a reflective layer 7 with a higher degree of reflection for visible light 11 can be used, wherein the increase in the degree of reflection for visible light 11 often automatically also results in an increase in the degree of reflection for infrared radiation 10. As a result, the visible light 11 emitted from the image display 6 onto the reflective layer 7 can be better visually perceived by the vehicle occupant and, at the same time, the condition of the vehicle occupant can be better determined by means of infrared radiation 10.

Reference is now made to FIGS. 4 and 5, in which enlarged cross-sectional views of the arrangement 1 are shown. FIG. 4 and FIG. 5 relate to further embodiments of the invention. The variants shown in FIGS. 4 and 5 corresponds substantially to the variant from FIG. 3 and FIG. 3A, so that only the differences will be discussed here, and reference is otherwise made to the description relating to FIG. 3 and FIG. 3A.

Unlike the variant from FIG. 3 and FIG. 3A, the opaque background 19 in FIG. 4 is not formed as a black screen print, but rather a partially coloured thermoplastic intermediate layer 14. The thermoplastic intermediate layer 14 is coloured in regions, with the opaque colouring appearing in a frame shape along the peripheral edge of the windscreen 5. The coloured area of the thermoplastic intermediate layer 14 is widened along the lower edge of the windscreen 5, so that the reflective layer 7 is arranged completely in front of the coloured area of the thermoplastic intermediate layer 14, i.e. the opaque background 19.

The windscreen 5 has a further pane 16, wherein the further pane 16 has an outer-side surface V facing the inner pane 13 and an interior-side surface VI facing away from the inner pane 13. The reflective layer 7 is applied over the entire surface of the outer-side surface V of the further pane 16 instead of on the inner pane 13. The further pane 16 is for example made of soda-lime glass and has a thickness of 1 mm. The further pane 16 does not extend over the entire surface of the windscreen 5, but rather has the same size as the reflective layer 7. The further pane 16 is arranged for example by means of an adhesive layer (not shown here) on the interior-side surface IV of the inner pane 13. The adhesive layer is arranged between the reflective layer 7 and the inner pane 13 and connects (glues) them together.

In the embodiment of the arrangement 1 according to the invention shown in FIG. 5, in addition to the radiation receiver 4 for infrared radiation 10, a further radiation receiver 17 is oriented toward the surface A of the image display 6 facing the windscreen 5. On the surface A of the image display 6 facing the windscreen 5, a functional layer 18 is also arranged, which has a light transmittance for p-polarised visible light of for example at least 70% and has a reflectance for s-polarised visible light 20 of for example 70%. The functional layer 18 is for example a broadband wire grid polarisation filter.

The windscreen 5 also has a further pane 16, wherein the further pane 16 has an outer-side surface V facing the inner pane 13 and an interior-side surface VI facing away from the inner pane 13. The reflective layer 7 is applied over the entire surface of the outer-side surface V of the further pane 16 instead of on the inner pane 13. The dimensions of the further pane 16, the arrangement on the windscreen 5 and the bonding of the further pane 16 to the inner pane 13 are equivalent to those of the embodiment of FIG. 4.

The further radiation receiver 17, the image display 6 with the functional layer 18 and the reflective layer 7 are arranged relative to one another in such a manner that an s-polarised light 20 reflected by the face 9 of the vehicle occupant, which strikes the reflective layer 7, is at least partially reflected by the reflective layer 7 toward the functional layer 18. The visible s-polarised light 20, which strikes the functional layer 18, is reflected by the functional layer 18 towards the further radiation receiver 17 and is received by the further radiation receiver 17. The image display 6 emits exclusively visible p-polarised light, at least 70% of which is transmitted through the functional layer 18. The visual perception of the virtual image projected onto the reflective layer 7 is thus hardly or not at all affected.

For example, a linear polariser and a circular polariser can be arranged between the further radiation receiver 17 and the functional layer 18 (not shown here). The linear polariser and circular polariser are arranged for example such that visible light, comprising portions of s-polarised light 20 and portions of p-polarised light, which is reflected by the functional layer 18 in the direction of the further radiation receiver 17, first strikes the linear polariser, wherein p-polarised light is absorbed and s-polarised light 20 is transmitted through the linear polariser. The s-polarised light 20 then transmits through the circular polariser and is accordingly circularly polarised and finally strikes the further radiation receiver, which at least partially receives the circularly polarised light. It may be that a portion of the circularly polarised light striking the further radiation receiver 17 is reflected at the further radiation receiver 17, for example on the lens for receiving the s-polarised light 20, with the opposite direction of rotation. The circularly polarised light reflected in this way, now with the opposite direction of rotation, first strikes the circular polariser again, where it changes its polarisation to p-polarisation during transmission through the circular polariser. The now p-polarised light then strikes the linear polariser and is absorbed by same. The linear polariser and circular polariser are also arranged for example in such a manner that a p-polarised residual light (scattered light) produced for technical reasons, which is emitted by the image display 6 and which is technically unavoidably directed at the further radiation receiver, is first transmitted through the functional layer 18 and then strikes the linear polariser, wherein the p-polarised residual light is absorbed.

By means of the further radiation receiver 17, further information about the vehicle occupant can be collected. This information can contribute to improving the assistance system 100. By arranging the reflective layer 7 in front of the opaque background 19, a reflective layer 7 with a higher reflectance for s-polarised visible light 20 can be used. This allows information about the condition of the vehicle occupant to be obtained more effectively. The further radiation receiver 17 can also be a camera that records the face 9 of the vehicle occupant continuously. The continuously recorded video can be used for example to communicate with other vehicle occupants or persons outside the vehicle 2. A video of a conversation participant could be projected onto the reflective layer 7 by means of the image display 6 so that the vehicle occupant and the conversation participant can see each other in real time.

### LIST OF REFERENCE SIGNS

1 Arrangement
2 Vehicle
3 Radiation source
4 Radiation receiver
5 Windscreen
6 Image display
7 Reflective layer
8 Infrared radiation-reflecting layer
9 Face of the vehicle occupant
10 Infrared radiation
11 Visible light
12 Outer pane
13 Inner pane
14 Thermoplastic intermediate layer
15 Infrared reflected radiation
16 Further pane
17 Additional radiation receiver
18 Functional layer
19 Opaque background
20 S-polarised light
100 Assistance system
I Outer-side surface of the outer pane 12
II Interior-side surface of the outer pane 12
III Outer-side surface of the inner pane 13
IV Interior-side surface of the inner pane 13
V Outer-side surface of the further pane 16
VI Interior-side surface of the further pane 16
A Surface of the image display 6 facing the windscreen 5
A-A′ Intersection line

1. An arrangement for an assistance system of a vehicle, comprising:
a radiation source for emitting infrared radiation,
a radiation receiver for receiving infrared radiation,
a windscreen with a reflective layer, and
an image display for emitting visible light, with an infrared radiation-reflecting layer,
wherein the image display is arranged relative to the reflective layer in such a manner that the visible light emitted by the image display can be reflected by the reflective layer toward a face of a vehicle occupant, and
wherein the radiation source and the radiation receiver are arranged relative to the infrared radiation-reflecting layer in such a manner that the infrared radiation emitted by the radiation source is reflected in the following order:
via the infrared radiation-reflecting layer, the reflective layer, the face of the vehicle occupant, the reflective layer and the infrared radiation-reflecting layer to the radiation receiver, and can be received by the radiation receiver, wherein the reflective layer, as seen by the vehicle occupant, is arranged completely in front of an opaque background of the windscreen when viewed through the windscreen.

2. The arrangement according to claim 1, wherein the infrared radiation-reflecting layer is arranged on a surface of the image display facing the windscreen and is permeable to visible light.

3. The arrangement according to claim 1, wherein the windscreen comprises an outer pane, a thermoplastic intermediate layer and an inner pane, and the reflective layer is arranged between the inner pane and the outer pane.

4. The arrangement according to claim 1, wherein the reflective layer is arranged on an interior-side surface of the windscreen closest to the vehicle occupant.

5. The arrangement according to claim 1, wherein the infrared radiation-reflecting layer consists of an alternating layer sequence of high refractive index layers with a refractive index greater than 1.9 and low refractive index layers with a refractive index less than 1.6.

6. The arrangement according to claim 5, wherein the high refractive index layers are formed on the basis of silicon nitride, aluminium nitride, tin-zinc oxide, silicon-zirconium nitride, silicon-aluminium nitride, silicon-titanium nitride, silicon-hafnium nitride or titanium oxide.

7. The arrangement according to claim 5, wherein the low refractive index layers are formed on the basis of silicon dioxide or doped silicon oxide.

8. The arrangement according to claim 1, wherein the reflective layer reflects at least 40% of visible light and infrared radiation.

9. The arrangement according to claim 1, further comprising a further radiation receiver for receiving visible s-polarised light.

10. The arrangement according to claim 9, wherein the image display has a functional layer which is transparent to p-polarised light and reflective to s-polarised light.

11. The arrangement according to claim 10, wherein the further radiation receiver and the functional layer are arranged relative to one another in such a manner that an s-polarised visible light reflected by the face of the vehicle occupant can be reflected via the reflective layer and then via the functional layer and received by the further radiation receiver.

12. An assistance system with a monitoring function for a vehicle occupant of a vehicle, comprising
an arrangement according to claim 1,
at least one actuator and/or at least one signal output device,
an electronic control device that is configured to acquire information about the vehicle occupant on the basis of an output signal of the radiation receiver, and to output an electrical signal to the at least one actuator for performing a mechanical action and/or to the at least one signal output device for outputting a visual and/or acoustic signal on the basis of the acquired information.

13. A method for monitoring a vehicle occupant of a vehicle, wherein an assistance system according to claim 12 is provided, and the method comprises:
a) emitting infrared radiation from the radiation source and reflecting the emitted infrared radiation to the radiation receiver in the following order: via the infrared radiation-reflecting layer, the reflective layer, the face of the vehicle occupant, the reflective layer, and the infrared radiation-reflecting layer,
b) receiving the infrared radiation by the radiation receiver,
c) acquiring information about the vehicle occupant by the electronic control device, and
d) based on the information, carrying out an action by the actuator and/or outputting an optical and/or acoustic signal by the signal output device.

14. A method comprising providing the arrangement according to claim 1 in an assistance system for the infrared-based monitoring of a vehicle occupant of a vehicle for traffic on land, water or in the air.

15. The arrangement according to claim 6, wherein the high refractive index layers are formed on the basis of silicon-zirconium nitride or titanium oxide.

16. The arrangement according to claim 8, wherein the reflective layer reflects at least 60% of visible light and infrared radiation.

17. The arrangement according to claim 16, wherein the reflective layer reflects at least 80% of visible light and infrared radiation.

18. The arrangement according to claim 9, further comprising a linear polariser arranged between the further radiation receiver and the image display.
